(19) United States
(12) Patent Application Publication
(10) Pub. No.: US 2002/0059112 A1
(43) Pub. Date: May 16, 2002

(54) Method, system, and computer system for processing electronic gift certificates, and computer-readable recording medium therefor

(75) Inventor: Chinami Hamatani, Cary, NC (US)

Correspondence Address: Gerald R. Woods, IBM Corporation, T81/503, P.O. Box 12195, Research Triangle Park, NC, 27709, US

(73) Assignee: International Business Machines Corporation, Armonk, NY

(21) Appl. No.: 10/008,512

(22) Filed: Nov. 8, 2001

(30) Foreign Application Priority Data
Nov. 15, 2000 (JP) 2000-348726

(51) Int. Cl. G06F 17/60

(52) U.S. Cl. 705/26

(57) ABSTRACT

The method uses a computer system or computer network and includes steps (11 to 16) for receiving an electronic gift certificate purchase request from a presenter; a step (20) for sending an electronic gift certificate from a business entity to a recipient; and steps (22 to 28) for receiving from the recipient a goods purchase request for purchasing goods from the business entity within the limits of the electronic gift certificate or with the electronic gift certificate being allotted thereto.

### FIELD OF THE INVENTION

The present invention relates to a method and system for processing (distributing) electronic gift certificates using a computer system or computer network.

### BACKGROUND ART

Gift certificates have conventionally been used for presents. Examples of such gift certificates include coupons specifying particular goods or commodities such as books, stationery, beer, rice, and train, plane, or other travel tickets, as well as coupons valid for any purchase at a particular department store or other retailer. Such coupons are like cash in that they have a certain monetary value, but unlike cash cannot be used freely and are subject to some restriction in goods for which the coupons can be exchanged or the stores where the coupons can be used. Coupons are commonly used as presents for graduations, childbirth, and other occasions when one would like to give a present but giving cash is not appropriate and the presenter cannot select an appropriate item and yet would like to give something while avoiding giving money.

Meanwhile, the spread of the Internet technologies has made on-line shopping increasingly common. On-line shopping typically requires a user to connect to an on-line shopping site, and operate on a screen, e.g., search for and display goods. The user then indicates an intention to purchase goods, and settles the transaction using a credit card, electronic money, or other means. The shopping site then ships the goods ordered after confirming valid settlement.

As noted above, the coupons have come to stay and been utilized as presents or gifts. However, as also described above, the conventional coupons have some limitations and, as a result, do not sufficiently consider the convenience of the recipient. For a coupon or gift certificate which is valid only at a particular department store, for example, it may not be convenient for the recipient to shop at that department store. In addition, it may require time and labor for the presenter to obtain or purchase a gift certificate. Gift certificates are generally sold only at particular sales counters, and the presenter must get to that sales counter in order to purchase a gift certificate.

Also, the gift certificate should be transferred in limited ways. For example, the gift certificate should be handed to a recipient in person, or sent by registered mail. If the recipient is normally absent because of work or other reason, the presenter would have to visit on a holiday or the recipient would have to go to the post office to receive delivery. Such circumstances are certainly not convenient for the presenter and the recipient.

### SUMMARY OF THE INVENTION

It is therefore an object of the present invention to provide a system and method for processing (delivering) electronic gift certificates which are safe and convenient for both presenter and recipient.

A method for processing electronic gift certificates according to the present invention using a computer system or computer network comprises the steps of receiving, from a presenter, a request for purchasing an electronic gift certificate including presenter information, recipient information, and usable amount of money; sending said electronic gift certificate to a recipient specified by said recipient information; and receiving, from said recipient, a request for purchasing goods at a business entity within the limits of said electronic gift certificate or with said electronic gift certificate being allotted thereto.

Security of communication in the step of sending the electronic gift certificate and the step of receiving the goods purchase request may be lower than that in the step of receiving the electronic gift certificate purchase request. A special benefit for a specific goods category or goods, or for a specific presenter or recipient may be annexed to the electronic gift certificate.

According to the above processing method, the electronic gift certificate can be conveniently purchased and used via a computer system or computer network. Also, the electronic gift certificate can be securely transferred via the computer system or computer network. Particularly, if a destination address for goods is specified when the electronic gift certificate is purchased, security can be improved because even if the content of communication between a user (recipient) of the electronic gift certificate and a business entity (shopping site) is stolen, the purchased goods will not be shipped to the thief because the shipping or destination address is specified at the time the electronic gift certificate is purchased.

A processing system, a computer system, and a computer-readable recording medium corresponding to the above processing method are also included in this invention.

### BRIEF DESCRIPTION OF THE DRAWINGS

FIG. 1 is a schematic diagram showing a system for processing electronic gift certificates according to one embodiment of the present invention.

FIG. 2 is a flow chart of an exemplary processing method according to another embodiment of the present invention.

FIG. 3 is a screen image of an exemplary application screen.

FIG. 4 is a screen image of an exemplary payment screen.

FIG. 5 illustrates an exemplary mail content of a notice to a recipient.

### PREFERRED EMBODIMENTS OF THE INVENTION

The preferred embodiments of the present invention will now be described in detail with reference to the drawings. It will be apparent to one with ordinary skill in the art that the present invention is not limited to the embodiments described below and can be implemented in many other ways. In the following, the same elements are identified by the same reference numerals throughout the description of the preferred embodiments.

It should also be noted that while the following embodiments are described primarily with regard to a method and system, it will be obvious to one with ordinary skill in the related art that this invention may also be implemented as a medium recording computer-executable program codes. It will therefore be obvious that this invention may be implemented in hardware, software, or a combination of hardware and software. Exemplary media for recording the program codes include any type of computer-readable storage media, including hard disks and other magnetic storage media, and CD-ROMs and other types of optical storage media.

A computer system (data processing system) that can be used with the present invention typically has a CPU, main memory (RAM:Random Access Memory), and nonvolatile storage (ROM:Read Only Memory) connected to a common bus. A coprocessor, graphics accelerator, cache memory, and input/output (I/O) devices are also usually connected to the bus. External storage, data input devices, display devices, and communications controller, for example, may also be connected to the bus through appropriate interfaces. It will also be obvious that other hardware resources commonly used with a computer system may be provided. The external storage is typically a hard disk drive, but is not be limited thereto and may include, for example, a magneto-optical disk drive, optical disk drive, flash memory or other type of semiconductor memory. Read-only storage such as CD-ROM may also be used as the external storage when appropriate for only reading data or programs. The data input devices may include a keyboard and a pointing device such as a mouse. A speech input device may also be used for data input. The display devices may include CRT, LCD, plasma display, and other types of flat panel displays or monitors. The computer system of the present embodiment may include a personal computer, workstation, mainframe computer, or any other computer.

The computer system of the present embodiment may be either a stand-alone computer system or a network of plural computer systems. Communications between the plural computer systems on the network can be performed through the Internet, local area network (LAN), wide area network (WAN), or other network. Communications lines used in the network may by either private lines or public lines.

The Internet as used herein may includes intranets and extranets. The computer network as used herein may also include both computer networks open to and accessible by the public, and computer networks open only to private access.

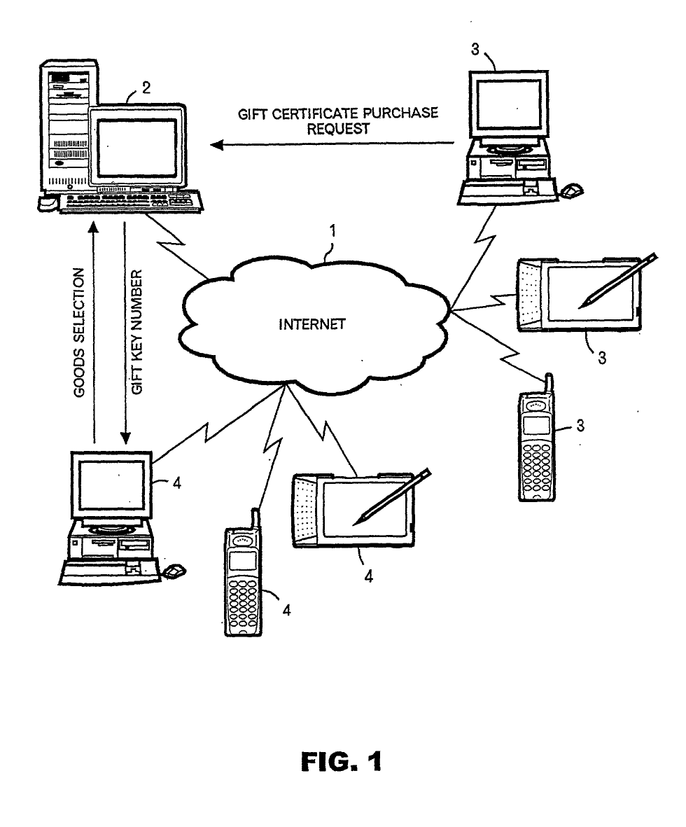

FIG. 1 is a schematic diagram of an electronic gift certificate processing system according to the preferred embodiment of the present invention. This electronic gift certificate processing system includes the Internet 1 to which a business entity server 2 providing services for processing electronic gift certificates, terminals 3 used by presenters utilizing these services, and terminals 4 used by recipients or presentees.

As is well known in the art, the Internet 1 is a computer network using TCP/IP (Transmission Control Protocol/Internet Protocol) or UDP (User Datagram Protocol). It will be obvious to one with ordinary skill in the art that while the Internet 1 is used by way of an example of a computer network, other computer networks using different communication protocols may also be used.

The electronic gift certificate as referred to herein is similar to the conventional gift certificate or coupon in that it is used to purchase goods within the limits of a specific face value, but the electronic gift certificate differs from the conventional paper coupon in that purchasing the electronic gift certificate and purchasing goods using the electronic gift certificate are processed electronically. The electronic gift certificate may be issued with no restrictions other than the face value, or with some restrictions regarding, for example, a period during which goods can be purchased, and goods or goods category for which the electronic gift certificate can be used. This will be described in detail later.

The business entity server 2 is a computer system maintained by a business entity which provides services according to this preferred embodiment. The general computer system such as described above may be used for the business entity server 2. The business entity in the present embodiment preferably supports a server for an on-line shopping service in addition to the electronic gift certificate processing service. However, it is not necessary for the business entity to provide the additional on-line shopping service, and the electronic gift certificate processing service could be provided through a tie-up with another on-line shopping business entity.

The terminals 3 and 4 may be a personal digital assistant (PDA), a cellular telephone, etc. as well as the general computer system described above. If the Internet 1 is used, the terminals 3 and 4 would have functions for sending HTTP (HyperText Transfer Protocol) requests and displaying documents written in HTML (HyperText Markup Language) or XML (Extensible Markup Language). Insofar as these functions are provided, various data processing devices other than computer systems, PDAs, and cellular phones may be used for the terminals 3 and 4.

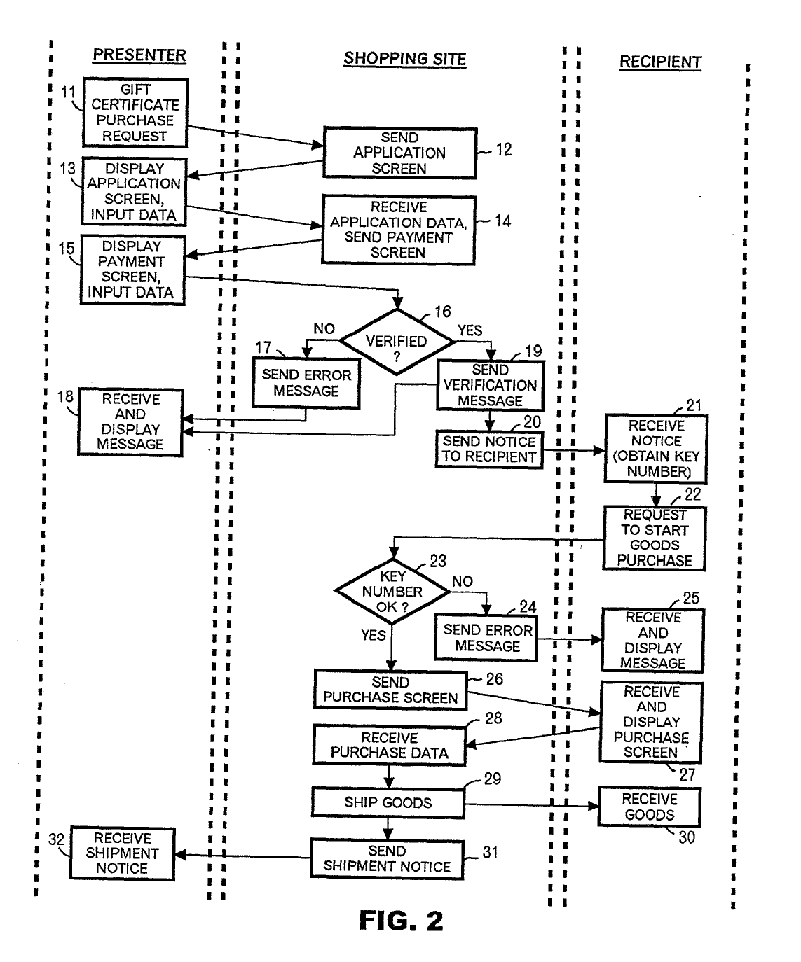

FIG. 2 is a flow chart of an exemplary electronic gift certificate processing method according to the present invention. Operations or processes performed by the presenter terminal 3 are shown in the left column, those performed by the business entity server 2 are shown in the middle column, and those performed by the recipient terminal 4 are shown in the right column.

The presenter terminal 3 first sends a request for purchasing an electronic gift certificate to the business entity server 2 (step 11). This request is sent by activating a suitable browser, for example, installed in the presenter terminal 3, and then sending an HTTP request specifying a URL of a purchase application Web page of the business entity server 2.

When the business entity server 2 receives this request, it sends data of the purchase application Web page (application screen) to the presenter terminal 3 (step 12). This purchase application Web page may be written in HTML or XML, for example. The presenter terminal 3 then interprets and displays the Web page using the installed browser (step 13).

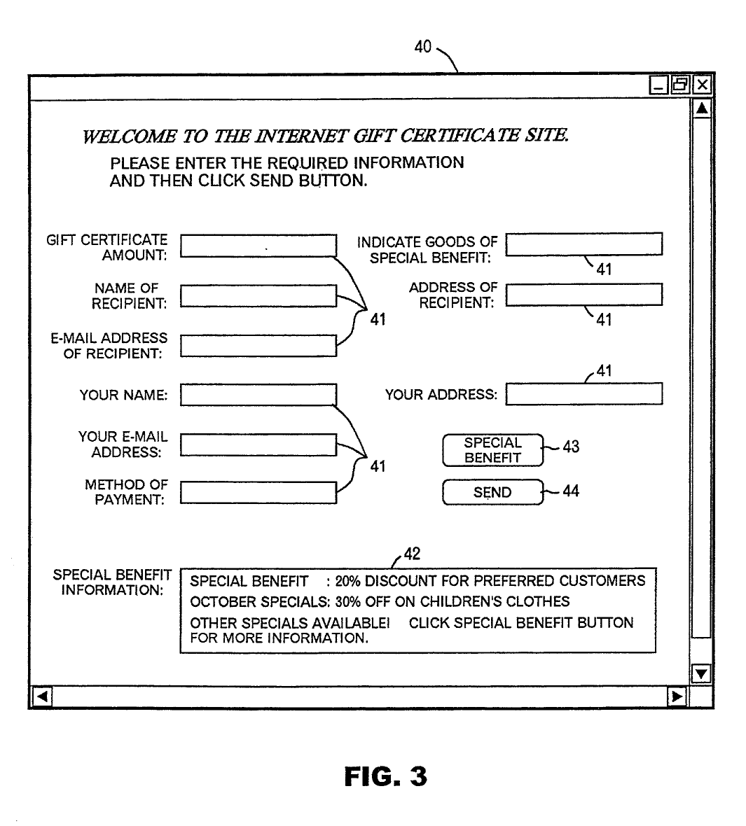

FIG. 3 illustrates an example of the application screen. Various messages and input fields 41 are presented inside a window 40. A gift certificate amount (face value of the electronic gift certificate), indication of goods of special benefit, recipient's name, recipient's address, recipient's e-mail address, presenter's name, presenter's address, presenter's e-mail address, and method of payment are entered to the respective input fields 41. Note that these input items are shown for an illustration purpose only. Other items may be added and one or more items described above may be omitted. It is, however, preferable to input the address of the recipient at this point. This enables the business entity to reference the entered recipient's address for shipping goods ordered as described later. Even if communication between the business entity and recipient is intercepted or hacked, the address of the recipient is valid insofar as communication between the business entity and presenter is secure. Therefore, no severe problems would arise in the operation of the present system even if security of communication between the business entity and the recipient is lowered.

Also, as shown in FIG. 3, special benefit information 42 may be presented in the window 40. The business entity could offer a special benefit to a presenter or user, such as price discount depending on frequency of use by the presenter, by recording a transaction history in association with the e-mail address of the presenter. The user may be managed by a user ID assigned to each user. Discount services available for a limited time period, discounts for specific products, and discounts for specific product categories may also be provided. The business entity could provide such discount services for overstocked products or products being promoted. If sales of a particular product category are being promoted to increase sales of wine, for example, then a discount could be provided on condition that the gift certificate is used for the promoted product (wine, in this example). If an electronic gift certificate is purchased with such a restriction or condition applied, use of the gift certificate (exchange with a product) is subject to the condition (sales period, product, or product category). It is possible to provide more detailed special benefit information in response to clicking on a special benefit button 43.

After entering the required information to the appropriate input fields 41, the user clicks a send button 44 to send the information to the business entity server 2 (step 13). The data entered to the input fields 41 are thus sent to and received by the business entity server 2. The business entity server 2 then sends payment information screen data to the presenter terminal 3 according to the selected method of payment (step 14).

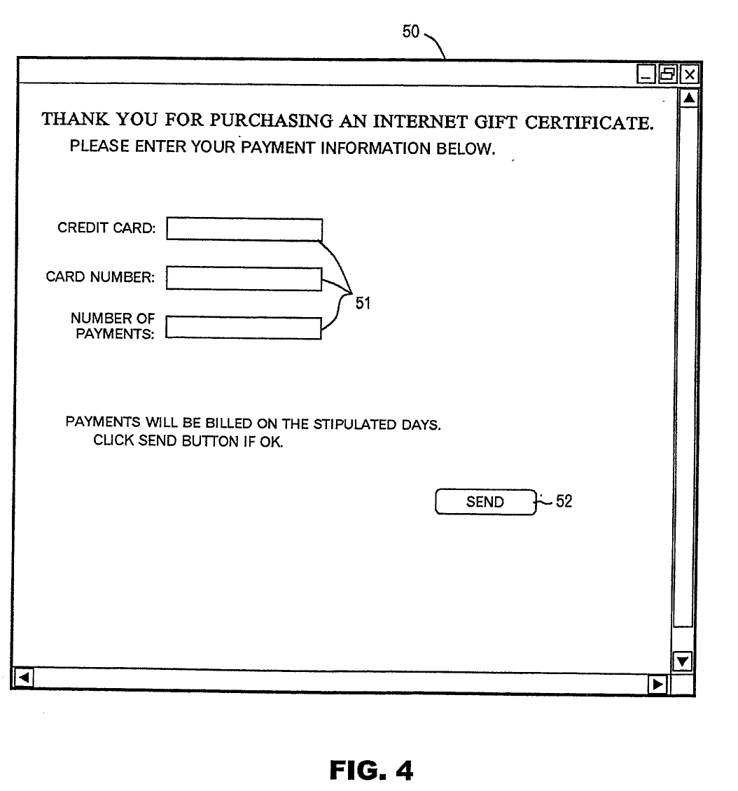

The presenter terminal 3 then displays the received payment information data (step 15). FIG. 4 illustrates an example of a payment screen when the user has selected to pay by a credit card. Input fields 51 are presented in a window 50. Required input data in this case include a type of a credit card used, credit card number, and the number of payments. The user then enters the required information in the appropriate input fields 51 and clicks a send button 52 to send the data to the business entity server 2 (step 15). Data may be typed directly into the input fields 51, or input by means of a combo box. While payment by the credit card is illustrated here, other payment methods, including electronic money, are also possible in which input items appropriate to a payment method selected will be required.

When the business entity server 2 receives the payment information, it verifies the information (step 16). Verification may be done by, for example, asking the credit card company to check the validity of the payment method. If verification fails, the business entity server 2 sends a message indicating that the application could not be accepted (step 17), and the message is displayed at the terminal 3 (step 18).

If verification is successful, the business entity server 2 sends a message indicating that the application has been accepted to the terminal 3 (step 19) where the message is displayed (step 18). After step 19, the business entity server 2 also sends a notice to the recipient terminal 4 via e-mail (step 20). This notice informs the recipient that an electronic gift certificate is presented to the recipient via the present system. When the recipient terminal 4 receives the mail (step 21), an appropriate e-mail program is invoked to read its message.

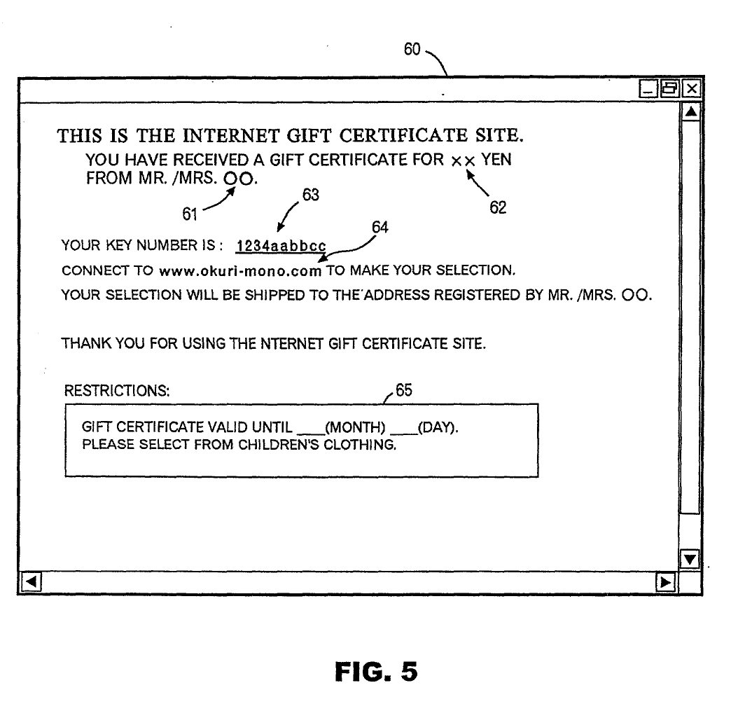

FIG. 5 illustrates an exemplary content of the mailed notice. A message displayed in the mail software window 60 indicates that an electronic gift certificate is presented to the recipient, which includes a presenter's name 61 and an amount or face value 62 of the electronic gift certificate. The mail content also contains a key number 63. The recipient uses this key number 63 as login data to access the business entity server 2 in order to exchange the electronic gift certificate for goods. The business entity server 2 references the key number 63 to manage the amount of the electronic gift certificate and any restriction that may apply, and to settle payment for purchasing goods. The mail content also contains a URL of a goods exchange (on-line shopping) page of the business entity server 2. The recipient uses this URL to access the goods exchange page and purchase goods in exchange of the electronic gift certificate. Applicable restrictions 65 may also be displayed in the window 60 as appropriate. This indicates any restriction applied when the presenter purchased the electronic gift certificate with the special benefit being applied. For example, if the electronic gift certificate is only valid for a certain period of time, the period is shown. If the gift certificate is restricted to a particular product or product category, this information is also shown. While not shown in the drawings, a special benefit may be contained in the mailed notice. This special benefit may be similar to the one provided to the presenter. For example, even if the presenter purchased the electronic gift certificate without any special benefit being applied (thus, there are no restrictions), a special benefit providing, for example, a discount if the electronic gift certificate is exchanged for a particular product or product category may be made available to the recipient. The recipient may determine whether to accept the special benefit.

While the key number is explicitly shown in FIG. 5, the key number could be embedded as an attribute of an anchor tag embedded in a URL if tags can be included in the e-mail data. The tag may be encoded as follows:

<a href=“http://www.okuri-mono.com/shopping.cgi ?& keynum=1234aabbcc”>http://www.okuri-mono.com/ </a>

If the key number is thus provided and the recipient then clicks on “http://www.okuri-mono.com/” displayed by the mailer software, the “shopping.cgi” program at “http://www.okuri-mono.com/”, is executed using “keynum=1234aabbcc” as an argument. Note that the CGI (common gateway interface) function is used in this example.

The recipient then sends a request to start purchasing goods (step 22). This request asks the business entity server 2 to send a goods exchange screen. The request may be done by clicking a linked URL in the mail content with which a key number is associated by an anchor tag, as described above.

In response to the request, the business entity server 2 verifies the key number using the CGI function (step 23). The business entity server 2 maintains a list of previously issued key numbers, and indicates successful verification if the key number is found in this list. It should be noted that even if the communication with the server is intercepted and the key number is stolen, such an action would be futile if the recipient's address has been previously registered. In other words, even if the key number is stolen, the purchased product will be sent to the recipient intended by the presenter and will never be sent to the address of any unauthorized user or stealer. As a result, there will be no significant damage. Thus, the present system provides highly robust protection against stealing. Since this system is a highly robust system against stealing, security of communications in the transmission of the key number and the exchange using the key number may not be so high. System overhead associated with encryption can thus be reduced.

If step 23 returns “no” because the key number verification failed, the business entity server 2 sends a message to the recipient terminal 4 which indicates that the key number is wrong (step 24), and the terminal 4 receives and displays this message (step 25). However, if step 23 returns “yes” because the verification was successful, the business entity server 2 sends a purchase or on-line shopping screen to the terminal 4 (step 26).

The terminal 4 then displays the purchase screen so that the user or recipient enters the required information (step 27). The business entity server 2 receives the information (step 28), and then exchanges the gift certificate for goods. The operation at this stage may be the same as the conventional on-line shopping. For example, the operation using a shopping cart (basket purchase), or the well-known search operation may be performed. Also, recommendations, banner advertisements or other information may be displayed. It should be apparent to one with ordinary skill in the related art that other general on-line shopping technologies may also be used with the present invention.

Then, the business entity server 2 makes arrangements to ship the goods (step 29). Needless to say, the address of the recipient associated with the key number can be referenced before shipping. As described above, using the pre-registered recipient address enables the goods to be safely received by the intended recipient without increasing the security of communication between the business entity server and recipient, although the security of communication between the presenter and the server 2 should be assured.

The recipient receives the shipped goods (step 30). The business entity server 2 then informs the presenter of the successful shipment (steps 31, 32). Note that the shipment of goods need not be handled by the business entity and may be handled by an external contractor. Also, the shipment notice to the presenter is not indispensable to the present system.

While the embodiments of on-line shopping have been described in which goods can be purchased within the limits of the face value of the electronic gift certificate, purchasing goods which exceeds the face value of the electronic gift certificate may be allowed if the user or recipient of the electronic gift certificate agrees additional payment for a shortfall. In that case, means for settling the transaction between the recipient and the business entity server 2 is required. Its payment method may be the same as that described above.

Furthermore, if the price of exchanged goods is lower than the face value of the electronic gift certificate, that is, if change is due, the difference may be accumulated in an account for use at some later time. The difference may be recorded in the business entity server 2 in association with the key number. This ability to use the difference at a later time is a distinctive feature not available with the conventional coupons. This feature is unique to the electronic gift certificates, and contributes to improving the convenience of the user.

Use of the electronic gift certificate processing method and system according to the present invention is substantially unrestricted with respect to time and place insofar as the users can connect to the Internet or other computer network, and the present invention thus provides a gift-giving system that is very convenient for both users, that is, presenters and recipients. Furthermore, registering the shipping address of the recipient at the time the electronic gift certificate is purchased makes stealing of the key number futile and provides a secure gift-giving system.

While the present invention has been described in detail with regard to the preferred embodiments thereof, the invention is not limited to the embodiments described above, and various changes and modifications can be made without departing from the scope of the present invention.

### ADVANTAGES OF THE INVENTION

According to the typical embodiments of the present invention as described herein, a system and method for processing electronic gift certificates are provided, which are secure and convenient for both presenters and recipients.

1. A method for processing electronic gift certificates using a computer system or computer network, comprising the steps of:
receiving, from a presenter, a request for purchasing an electronic gift certificate including presenter information, recipient information, and usable amount of money;
sending said electronic gift certificate to a recipient specified by said recipient information; and
receiving, from said recipient, a request for purchasing goods at a business entity within the limits of said electronic gift certificate or with said electronic gift certificate being allotted thereto.

2. The method as described in claim 1, wherein security of communication in said steps of sending said electronic gift certificate and receiving said goods purchase request is lower than that in said step of receiving said electronic gift certificate purchase request.

3. The method as described in claim 1 or 2, wherein a special benefit for a specific goods category or goods, or for a specific presenter or recipient is annexed to said electronic gift certificate.

4. A system for processing electronic gift certificates using a computer system or computer network, comprising:
means for receiving, from a presenter, a request for purchasing an electronic gift certificate including presenter information, recipient information, and usable amount of money;
means for sending said electronic gift certificate to a recipient specified by said recipient information; and
means for receiving, from said recipient, a request for purchasing goods at a business entity within the limits of said electronic gift certificate or with said electronic gift certificate being allotted thereto.

5. The system as described in claim 4, wherein security of communication in said means for sending said electronic gift certificate and said means for receiving said goods purchase request is lower than that in said means for receiving said electronic gift certificate purchase request.

6. The system as described in claim 4 or 5, further comprising means for annexing to said electronic gift certificate a special benefit for a specific goods category or goods, or for a specific presenter or recipient.

7. A computer system configured as a system for processing electronic gift certificates, comprising:
means for accepting a purchase application for an electronic gift certificate from a presenter and settling a purchase transaction therefor;
means for sending said electronic gift certificate to a recipient; and
means for accepting, from said recipient, a purchase application for goods within the limits of said electronic gift certificate or with said electronic gift certificate being allotted thereto.

8. The computer system as described in claim 7, wherein security of communication in said means for sending said electronic gift certificate and said means for accepting said purchase application for goods is lower than that in said means for accepting said purchase application for said electronic gift certificate and settling said purchase transaction.

9. The computer system as described in claim 7 or 8, wherein means for annexing a special benefit for a specific goods category or goods, or for a specific presenter or recipient is provided in said means for accepting said purchase application for said electronic gift certificate and settling said purchase transaction, or said means for accepting said purchase application for goods.

10. A computer-readable recording medium recording a program to be executed by a computer to process electronic gift certificates, said program having the following functions implemented by said computer:
a function for accepting a purchase application for an electronic gift certificate from a presenter and settling a purchase transaction therefor;
a function for sending said electronic gift certificate to a recipient; and
a function for accepting, from said recipient, a purchase application for goods within the limits of said electronic gift certificate or with said electronic gift certificate being allotted thereto.
